(19) United States
(12) Patent Application Publication
(10) Pub. No.: US 2007/0121912 A1
(43) Pub. Date: May 31, 2007

(54) Communication device, communication method and communication system

(75) Inventor: Masaki Kotani, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/546,399

(22) Filed: Oct. 12, 2006

(30) Foreign Application Priority Data
Oct. 14, 2005 (JP) 2005-300389

(51) Int. Cl. H04M 1/00; H04M 3/00

(52) U.S. Cl. 379/355.04

(57) ABSTRACT

A communication device is connected to a first information management device in a manner such that communication can be carried out. The communication device includes a destination accepting unit, a determination unit, and a communication control unit. The destination accepting unit accepts an entry of second destination identification information, which is information for identifying a destination, from outside. The determination unit determines whether or not the first destination identification information corresponding to the second destination identification information is stored in the destination storage unit. The communication control unit permits communication with a destination corresponding to the second destination identification information when a determination is made that the first destination identification information corresponding to the second destination identification information is stored in the destination storage unit.

### BACKGROUND OF THE INVENTION

1. Field of the Invention

The present invention relates to a communication device connected to an information management device in a manner such that communication can be carried out. The information management device stores destination identification information, which is information for identifying a destination (for example, a facsimile number and an electronic mail (hereinafter referred to as “mail”) address), and destination name information corresponding to the destination identification information.

2. Description of the Related Art

A communication device is connected to an information management device, which stores telephone directory data, in a manner such that communication can be carried out. The telephone directory data includes destination identification information, which is information for identifying a destination (for example, a facsimile number and a mail address), and destination name information corresponding to the destination identification information. Such a conventional communication device receives the telephone directory data from the information management device, and accepts a selection made by a user regarding the destination name information included in the received telephone directory data. Then, the communication device carries out communication with a destination corresponding to the destination name information (or the destination identification information) selected by the user.

The conventional communication device accepts an entry of the destination identification information made by the user, and carries out communication with a destination corresponding to the destination identification information entered by the user. When the user enters wrong destination identification information, the communication is carried out with a destination corresponding to the wrong destination identification information, i.e. an unintended destination. Thus, convenience for the user is insufficient.

### SUMMARY OF THE INVENTION

In order to overcome the problems described above, preferred embodiments of the present invention provide a communication device which can prevent communication from being carried out with an unintended destination.

According to a preferred aspect of the present invention, the communication device is connected to a prescribed number of information management devices in a manner such that communication can be carried out. The information management device includes a destination storage unit which stores destination name information by associating it with first destination identification information, which is information for identifying a destination, for each destination. The communication device includes a destination accepting unit, a determination unit, and a permission unit. The destination accepting unit accepts an entry of second destination identification information, which is information for identifying a destination, from outside. The determination unit determines whether or not the first destination identification information corresponding to the second destination identification information is stored in the destination storage unit. When the determination unit determines that the first destination identification information corresponding to the second destination identification information is stored in the destination storage unit, the permission unit permits the communication with the destination corresponding to the second destination identification information.

Thus, when the first destination identification information corresponding to the second destination identification information is stored in the destination storage unit of the information management device, the communication with the destination corresponding to the second destination identification information is permitted, and the communication is carried out with the destination corresponding to the second destination identification information. That is, when the first destination identification information corresponding to the second destination identification information is not stored in the destination storage unit of the information management device, the communication with the destination corresponding to the second destination identification information is not permitted, and the communication is not carried out with the destination corresponding to the second destination identification information. Therefore, it is possible to prevent the communication from being carried out with the destination corresponding to the destination identification information entered by mistake, i.e., an unintended destination. Alternatively, a communication destination may be limited to the destination stored in the destination storage unit.

According to another preferred aspect of the present invention, the communication device includes a first transmission unit and a first reception unit. The first transmission unit transmits information requesting a return of presence/absence information along with the second destination identification information to the information management device. Further, the presence/absence information is information regarding whether or not the first destination identification information corresponding to the second destination identification information is stored in the destination storage unit. The first reception unit receives the presence/absence information returned from the information management device. The determination unit determines whether or not the first destination identification information corresponding to the second destination identification information is stored in the destination storage unit in accordance with the presence/absence information received by the first reception unit.

Thus, the determination as to whether or not the first destination identification information corresponding to the second destination identification information is stored in the destination storage unit of the information management device can be carried out by a simple process.

According to another preferred aspect of the present invention, the communication device includes a second transmission unit and a second reception unit. The second transmission unit transmits information requesting a return of the first destination identification information and the destination name information stored in the destination storage unit to the information management device. The second reception unit receives the first destination identification information and the destination name information returned from the information management device. The determination unit searches the first destination identification information corresponding to the second destination identification information from the first destination identification information and the destination name information received by the second reception unit to determine whether or not the first destination identification information corresponding to the second destination identification information is stored in the destination storage unit.

Thus, a period of time when the communication device and the information management device is connected is shortened. The information management device is not required to determine whether or not the first destination identification information corresponding to the second destination identification information is stored in the destination storage unit of the information management device. As a result, a processing load of the information management device is reduced.

According to another preferred aspect of the present invention, the communication device includes a notification unit which notifies information that the communication cannot be carried out when the permission unit does not permit the communication with the destination corresponding to the second destination identification information.

Therefore, when the first destination identification information corresponding to the second destination identification information is not stored in the destination storage unit of the information management device and the communication with the destination corresponding to the second destination identification information is not stored, the information indicating that the communication cannot be carried out is notified. Therefore, the user can recognize that the user has entered a wrong destination.

According to another preferred aspect of the present invention, the communication device includes a setting accepting unit which accepts a selection entry from the outside and carries out either a first setting or a second setting. The first setting permits the communication only when the first destination identification information corresponding to the second destination identification information is stored in the destination storage unit. The second setting permits the communication regardless of whether or not the first destination identification information corresponding to the second destination identification information is stored in the destination storage unit. When the setting accepting unit accepts a selection entry corresponding to the second setting, the permission unit permits the communication with the destination corresponding to the second destination identification information regardless of the determination by the determination unit.

Therefore, the user can select either the first setting or the second setting. As a result, convenience for the user improves.

According to another preferred aspect of the present invention, the communication device includes a first acquiring unit, a first storage unit, and a first prohibiting unit. The first acquiring unit acquires first individual authentication information, which is information for authenticating an individual, from the outside. The first storage unit previously stores second individual authentication information, which is information for authenticating an individual. The first prohibiting unit prohibits the setting of the setting accepting unit when the first individual authentication information acquired by the first acquiring unit does not match with the second individual authentication information stored in the first storage unit.

When the first individual authentication information does not match with the second individual authentication information, the first setting or the second setting is prohibited. Therefore, it is possible to prevent a change from being made to the setting without an authentication of an individual. For example, a user other than a user whose second individual authentication information is stored in the first storage unit (for example, a manager, a person in charge) may be permitted to use the first setting. Therefore, a communication destination may be limited to a destination stored in the destination storage unit.

According to another preferred aspect of the present invention, the prescribed number is a plural number. The communication device is connected to a plurality of information management devices in a manner that the communication can be carried out. The communication device also includes a device selection accepting unit. The device selection accepting unit accepts a selection of one information management device among the prescribed number of information management devices from the outside. The determination unit determines whether or not the first destination identification information corresponding to the second destination identification information is stored in the destination storage unit of the information management device selected and accepted by the device selection accepting unit.

Therefore, the user can select an information management device, which predetermined first destination identification information is stored in the destination storage unit, from the plurality of the information management devices. Thus, convenience for the user improves. For example, when using a communication device in a company, first destination identification information of other branch office or a head office of the same company is stored in one information management device, and first destination identification information of another company such as a customer is stored in another information management device. In such a case, when selecting the information management device storing the first destination identification information of other branch office or the head office of the same company, it is possible to prevent the communication from being carried out erroneously with another company and prevent leakage of confidential information or the like.

According to another preferred aspect of the present invention, the communication device includes a second acquiring unit, a second storage unit, and a second prohibiting unit. The second acquiring unit acquires third individual authentication information, which is information for authenticating an individual, from the outside. The second storage unit previously stores fourth individual authentication information, which is information for authenticating an individual. When the third individual authentication information acquired by the second acquiring unit does not match with the fourth individual authentication information stored in the second storage unit, the second prohibiting unit prohibits the device selection accepting unit from accepting a selection.

Therefore, when the third individual authentication information does not match with the fourth individual authentication information, the device selection accepting unit is prohibited from accepting the selection of the information management device. Therefore, it is possible to prevent the information management device from being selected without an authentication of an individual. For example, when a user other than a user whose fourth individual authentication information is stored in the second storage unit (for example, a manager, a person in charge) uses the communication device, the information management device cannot be selected. Therefore, a communication destination may be limited to a destination stored in the destination storage unit of a specific information management device.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating an example of a communication device according to a preferred embodiment of the present invention.

FIG. 2 illustrates an example of telephone directory data.

FIG. 3 is a block diagram illustrating an example of a functional configuration of a control unit.

FIG. 4 is a flowchart illustrating an example of an operation carried out by the communication device.

FIG. 5 is a flowchart illustrating an example of an operation carried out by the communication device.

### DETAILED DESCRIPTION OF PREFERRED EMBODIMENTS

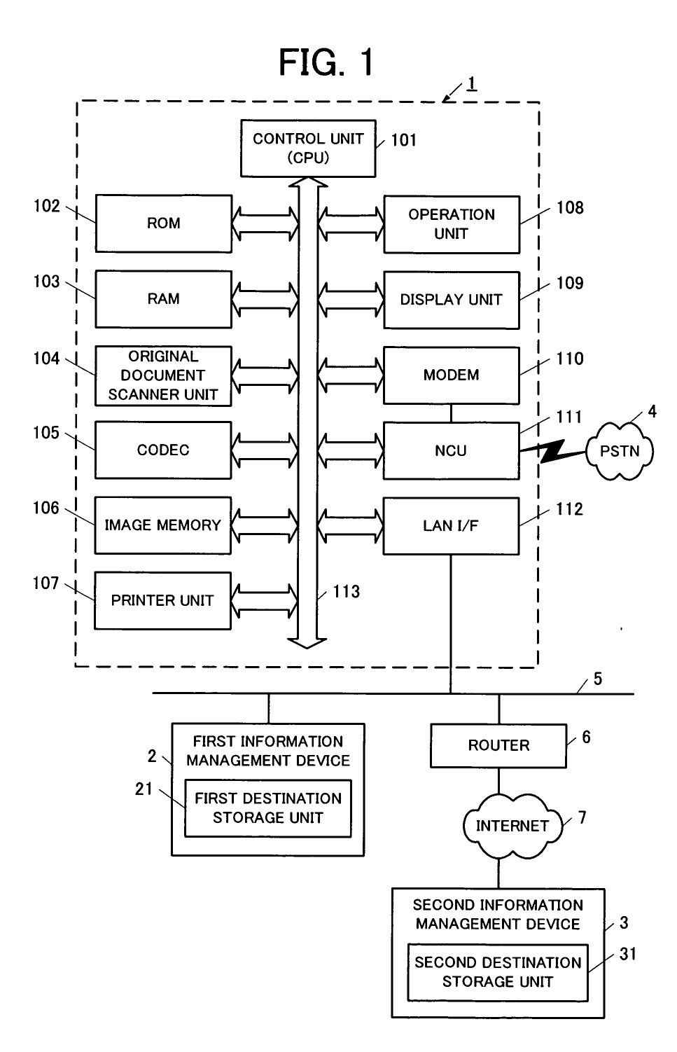

Preferred embodiments of the present invention will be described with reference to the drawings. FIG. 1 is a block diagram illustrating an example of a communication device 1 according to a preferred embodiment of the present invention. As illustrated in FIG. 1, the communication device 1 includes a control unit (Central Processing Unit (CPU)) 101, a Read Only Memory (ROM) 102, a Random Access Memory (RAM) 103, an original document scanner unit 104, a Coder Decoder (CODEC) 105, an image memory 106, a printer unit 107, an operation unit 108, a display unit 109, a Modulator Demodulator (MODEM) 110, a Network Control Unit (NCU) 111, and a Local Area Network Interface (LAN I/F) 112. Each of components 101 through 112 is connected via a bus 113 in a manner that communication can be carried out. The communication device 1 includes a facsimile function for transmitting and receiving image data by facsimile, and an Internet facsimile function for transmitting and receiving image data by mail.

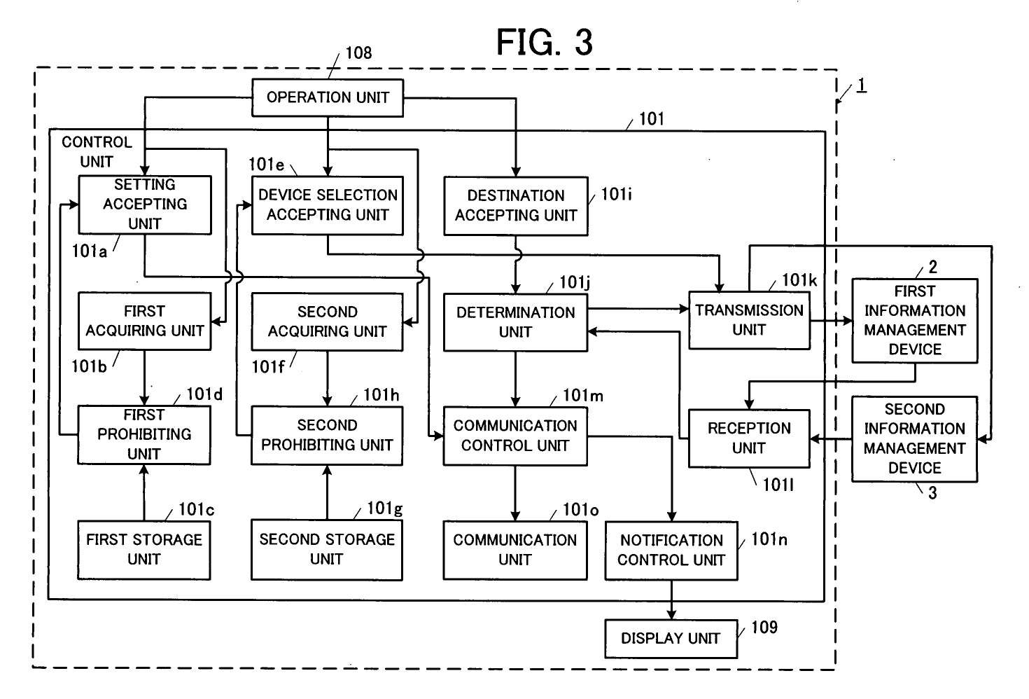

The control unit 101 controls each component of the communication device 1 in accordance with a control program stored in the ROM 102. The control unit 101 functions as a setting accepting unit 101a (refer to FIG. 3) or the like described hereinafter. The RAM 103 functions as a main memory and a working area or the like of the control unit 101.

The original document scanner unit 104 scans an image of an original document to generate image data, and outputs the generated image data to a prescribed output destination. Although not illustrated in the drawings, the original document scanner unit 104 includes a Flat Bed Scanner (FBS) and an original document feeding mechanism or the like. The FBS includes an optical system including a Charge Coupled Device (CCD) image sensor and a light source or the like. The original document feeding mechanism is an Automatic Document Feeder (ADF) or the like. The CODEC 105 encodes image data and decodes (develops) encoded image data for copying and facsimile transmission and reception or the like.

The image memory 106 stores image data directly output from the original document scanner unit 104, image data encoded by the CODEC 105, and received image data or the like. The printer unit 107 prints out image data retrieved from the image memory 106. For example, the printer unit 107 uses an electrophotographic printing method.

The operation unit 108 includes entry keys and a touch screen or the like for the user to enter various pieces of information. The user performs various input operations from the operation unit 108. The entry keys include a start key for instructing a start of communication, a ten-key numeric pad for entering a facsimile number or the like, and a cursor key for carrying out various settings, or the like. The display unit 109 includes a Liquid Crystal Display (LCD) and a Light Emitting Diode (LED) lamp or the like arranged next to the operation unit 108, for example. The LCD displays various setting status and an operation state of the communication device 1 or the like using characters and figures or the like. The LED lamp displays various setting status and an operation state of the communication device 1 or the like by being turned on and off.

The MODEM 110 modulates and demodulates transmission data and received data in accordance with, for example, the International Telecommunication Union-Telecommunications (ITU-T) recommendation V.30 standard or anything similar to this. The NCU 111 is a communication network control device that controls a telephone line for making or hanging up a telephone call. The NCU 111 is connected to a Public Switched Telephone Network (PSTN) 4. The control unit 101 controls the MODEM 110 and the NCU 111 to carry out facsimile transmission and reception of image data.

The LAN I/F 112 connects a LAN 5 and the communication device 1 in a manner that communication can be carried out. A first information management device 2 (corresponding to an information management device) and a router 6 are connected to the LAN 5. A second information management device 3 (corresponding to an information management device) is connected to the LAN 5 via the router 6 and the Internet 7. Therefore, the communication device 1 is connected to the first information management device 2 and the second information management device 3 in a manner that communication can be carriedout. The first information management device 2 is a Lightweight Directory Access Protocol (LDAP) server including an LDAP. The first information management device 2 includes a first destination storage unit (corresponding to means for storing a destination), which stores destination name information by associating it with first destination identification information for each destination. Further, the first destination identification information is information for identifying a destination (for example, a facsimile machine and a mail address).

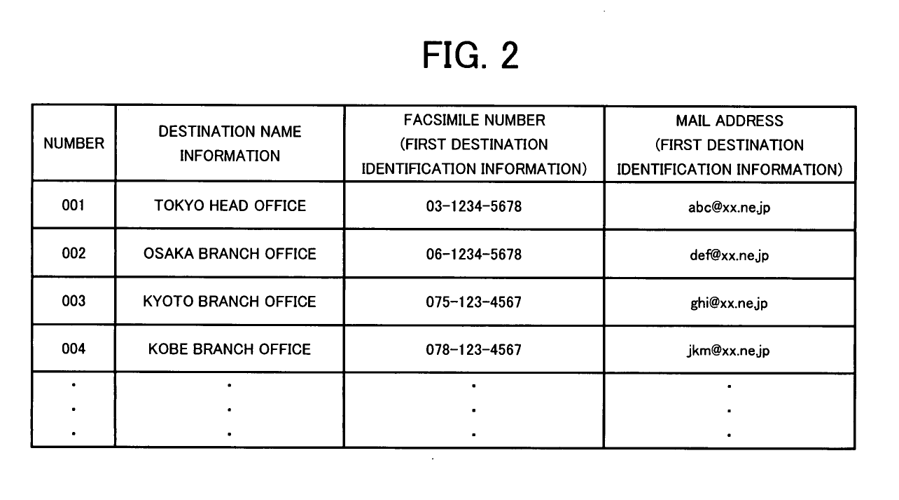

FIG. 2 illustrates an example of telephone directory data including the destination name information and the first destination identification information stored in the first destination storage unit 21. The destination name information and the facsimile number or the like included in the telephone directory data are entered by the user via an operation unit (not illustrated) of the first information management device 2 and written in the first destination storage unit 21. As illustrated in FIG. 2, the telephone directory data includes a “number” field, a “destination name information” field, a “facsimile number (first destination identification information)” field, and a “mail address (first destination identification information)” field. Information in the same record is stored by being associated one with the other. The “number” field stores a number assigned according to an order in which the destination name information, the facsimile number or the like has been written. The “destination name information”field stores a name of a destination (forexample, Tokyo Head Office, and Osaka Branch Office). The “facsimile number” field stores a facsimile number of a destination (for example, 03-1234-5678, and 06-1234-5678). The “mail address” field stores a mail address of a destination (for example, abc@xx.ne.jp, and def@xx.ne.jp).

Further, the second information management device 3 has the same configuration as the first information management device 2. However, although the second information management device 3 includes a second destination storage unit 31 (corresponding to means for storing a destination), first destination identification information and destination name information (i.e., telephone directory data) stored in the destination storage unit 31 differ from the first destination identification information and the destination name information (i.e., the telephone directory data) stored in the destination storage unit 21 of the first information management device 2. In the above description, two information management devices are connected to the communication device 1 in a manner that communication can be carried out. However, the present invention is not limited to such an example. One communication management device or more than two communication management devices may be connected to the communication device 1 in a manner that communication can be carried out.

Next, a description will be made of a functional configuration of the control unit 101. As illustrated in FIG. 3, the control unit 101 functionally includes a setting accepting unit 101a, a first acquiring unit 101b, a first storage unit 101c, a first prohibiting unit 101d, a device selection accepting unit 101e, a second acquiring unit 101f, a second storage unit 101g, a second prohibiting unit 101h, a destination accepting unit 101i, a determination unit 101j, a transmission unit 101k, a reception unit 1011, a communication control unit 101m, a notification control unit 101n, and a communication unit 101o.

The setting accepting unit 101a (corresponding to means for accepting a setting) accepts a selection entry via the operation unit 108 from the outside and carries out either a first setting or a second setting. That is, among the first setting and the second setting, the selected and accepted setting is set with the communication control unit 101m. Further, the first setting permits communication only when the first destination storage unit 21 of the first information management device 2 (or the second destination storage unit 31 of the second information management device 3) stores the first destination identification information corresponding to the second destination identification information. The second setting permits communication regardless of whether or not the first destination storage unit 21 of the first information management device 2 (or the second destination storage unit 31 of the second information management device 3) stores the first destination identification information corresponding to the second destination identification information.

The first acquiring unit 101b (corresponding to a first acquiring means) acquires first individual authentication information, which is information for authenticating an individual, from the outside. For example, the first individual authentication information includes a user ID and a password. The first acquiring unit 101b acquires a user ID and a password entered by the user from the operation unit 108.

The first storage unit 101c (corresponding to a first storing means) stores second individual authentication information, which is information for authenticating an individual. For example, the second individual authentication information includes a user ID (for example, a prescribed character string including a plurality of alpha-numerals, e.g. “001”) and a password (for example, a prescribed character string including a plurality of alpha-numerals, e.g. “abcd1234”). The first storage unit 101c stores the user ID and the password as the second individual authentication information.

When the first individual authentication information acquired by the first acquiring unit 101b does not match with the second individual authentication information stored in the first storage unit 101c, the first prohibiting unit 101d (corresponding to a first prohibiting means) prohibits a setting of the setting accepting unit 101a. That is, when the first individual authentication information acquired by the first acquiring unit 101b matches with the second individual authentication information stored in the first storage unit 101c, the setting accepting unit 101a accepts a selection of either the first setting or the second setting. Then, the selected setting is set with the communication control unit 101m. Thus, when the user enters the first individual authentication information that is the same as the second individual authentication information (in this example, a user ID and a password) stored in the communication device 1 from the operation unit 108, the user can select either the first setting or the second setting from the operation unit 108.

The device selection accepting unit 101e (corresponding to a device selection accepting means) accepts a selection of one information management device from a prescribed number of information management devices via the operation unit 108 from the outside. Further, in the present preferred embodiment, the prescribed number is two, and the two information management devices are the first information management device 2 and the second information management device 3. The device selection accepting unit 101e outputs information of the selected first information management device 2 or the second information management device 3 to the transmission unit 101k.

The second acquiring unit 101f (corresponding to a second acquiring means) acquires third individual authentication information, which is information for authenticating an individual, from the outside. In the present preferred embodiment, the third individual authentication information includes a user ID and a password. The second acquiring unit 101f acquires the user ID and the password entered by the user from the operation unit 108.

The second storage unit 101g (corresponding to a second storing means) stores fourth individual authentication information, which is information for authenticating an individual. In the present preferred embodiment, the fourth individual authentication information includes a user ID (a prescribed character string including a plurality of alpha-numerals, for example, “002”) and a password (a prescribed character string including a plurality of alpha-numerals, for example, “efgh5678”). The second storage unit 101g stores the user ID and the password.

The second prohibiting unit 101h (corresponding to a second prohibiting means) prohibits the device selection accepting unit 101e from accepting a selection when the third individual authentication information acquired by the second acquiring unit 101f does not match with the fourth individual authentication information stored in the second storage unit 101g. That is, when the third individual authentication information acquired by the second acquiring unit 101f does not match with the fourth individual authentication information stored in the second storage unit 101g, the device selection accepting unit 101e accepts a selection of either the first information management device 2 or the second information management device 3. Therefore, when the third individual authentication information that is the same as the fourth individual authentication information (in the present preferred embodiment, the user ID and the password) stored in the communication device 1 is entered from the operation unit 108, the user can select either the first information management device 2 or the second information management device 3 from the operation unit 108.

The above description relates to an example in which different pieces of individual authentication information (the second individual authentication information and the fourth individual authentication information) are stored in the first storage unit 101c and the second storage unit 101g. However, the second individual authentication information and the fourth individual authentication information may be the same. The above description relates to an example in which the individual authentication information is the user ID and the password. However, the present invention is not limited to such an example. For example, the individual authentication information may be biological information such as a fingerprint, a retina, an iris, or a voiceprint. In this case, the biological information may be previously stored, and biological information may be acquired from a living body (the user).

The destination accepting unit 101i (corresponding to a destination accepting means) accepts an entry of the second destination identification information (for example, a facsimile number and a mail address), which is information for identifying the destination, via the operation unit 108 from the outside. That is, the destination accepting unit 101i accepts the second destination identification information entered by the user from the operation unit 108. The determination unit 101j (corresponding to means for determining) determines whether or not the first destination identification information corresponding to the second destination identification information is stored in the destination storage unit of the information management device selected and accepted by the device selection accepting unit 101e. To carry out the determination, the determination unit 101j outputs prescribed information (command) to the transmission unit 101k. Further, when the control unit 101 determines that a communication start command has been accepted, the determination unit 101j carries out the determination. For example, when the destination accepting unit 101i accepts an entry of the second destination identification information, when an original document is placed on a prescribed position of the communication device 1 and a start key of the operation unit 108 is operated, the control unit 101 determines that a communication start command has been accepted.

When the transmission unit 101k (corresponding to a first transmitting means) accepts prescribed information from the determination unit 101j, the transmission unit 101k transmits the second destination identification information, which has been accepted by the destination accepting unit 101i, and information requesting a return of presence/absence information to the information management device selected and accepted by the device selection accepting unit 101e. Further, the presence/absence information is information regarding whether or not the first destination identification information corresponding to the second destination identification information is stored in the destination storage unit. For example, when the device selection accepting unit 101e accepts a selection of the first information management device 2 and the destination accepting unit 101i accepts “06-1234-5678” as the second destination identification information, the transmission unit 101k transmits “06-1234-5678” and information requesting a return of the presence/absence information, which is information regarding whether or not the first identification information corresponding to “06-1234-5678” is stored in the first destination storage unit 21, to the first information management device 2.

Meanwhile, when the first information management device 2 (or the second information management device 3) receives the information from the transmission unit 101k, the first information management device 2 (or the second information management device 3) determines whether or not the first destination identification information corresponding to the second destination identification information is stored in the first destination storage unit 21 (or the second destination storage unit 31). Then, the first information management device 2 (or the second information management device 3) returns the presence/absence information, which is information indicating such a fact, to the communication device 1. For example, when the first information management device 2 receives “06-1234-5678” as the second destination identification information and the information requesting a return of the presence/absence information, the first information management device 2 searches the first destination identification information corresponding to “06-1234-5678” from the first destination storage unit 21 (i.e., telephone directory data). Accordingly, the first information management device 2 determines whether or not the first destination identification information corresponding to “06-1234-5678” is stored. When the telephone directory data illustrated in FIG. 2 is stored, the first destination identification information corresponding to “06-1234-5678” is stored. Therefore, the first information management device 2 returns the information indicating that the first destination identification information corresponding to “06-1234-5678” is stored in the first destination storage unit 21 to the communication device 1.

For example, when the first information management device 2 receives the information requesting a return of the presence/absence information along with “06-1234-5678” as the second destination identification information, the first information management device 2 searches the first destination identification information corresponding to “06-1234-5678” from the first destination storage unit 21 (i.e. telephone directory data). Accordingly, the first information management device 2 determines whether or not the first destination identification information corresponding to “06-1234-5678” is stored. When the telephone directory data illustrated in FIG. 2 is stored, the first destination identification information corresponding to “06-1234-5678” is not stored. Therefore, the first information management device 2 returns information indicating that the first destination identification information corresponding to “06-1234-567” is not stored in the first destination storage unit 21 to the communication device 1.

The reception unit 1011 (corresponding to a first receiving means) receives the presence/absence information returned from the information management device. The determination unit 101j determines whether or not the first destination identification information corresponding to the second destination identification information is stored in the destination storage unit of the information management device selected and accepted by the device selection accepting unit 101e based on the presence/absence information received by the reception unit 1011. For example, when the reception unit 1011 receives the information indicating that the first destination identification information corresponding to the second destination identification information is stored in the first destination storage unit 21, the determination unit 101j determines that the first destination identification information corresponding to the second destination identification information is stored in the first destination storage unit 21 of the first information management device 2. As another example, when the reception unit 1011 receives information indicating that the first destination identification information corresponding to the second destination identification information is not stored in the first destination storage unit 21, the determination unit 101j determines that the first destination identification information corresponding to the second destination identification information is not stored in the first destination storage unit 21 of the first information management device 2.

When a first setting is set by the setting accepting unit 101a, in case the determination unit 101j determines that the first destination identification information corresponding to the second destination identification information is stored in the destination storage unit of the selected and accepted information management device, the communication control unit 101m (corresponding to means for permitting) permits communication with a destination corresponding to the second destination identification information. That is, when a selection entry corresponding to the first setting is accepted by the setting accepting unit 101a, in case the determination unit 101j determines that the first destination identification information corresponding to the second destination identification information is stored, the communication control unit 101m permits communication with the destination corresponding to the second destination identification information. In case the determination unit 101j determines that the first destination identification information corresponding to the second destination identification information is not stored, the communication control unit 101m does not permit communication with the destination corresponding to the second destination identification information, and prohibits the communication with the destination corresponding to the second destination identification information.

When a selection entry corresponding to the second setting is accepted by the setting accepting unit 101a, regardless of the determination by the determination unit 101j, the communication control unit 101m permits the communication with the destination corresponding to the second destination identification information. For example, when a selection entry corresponding to the second setting is accepted by the setting accepting unit 101a, even when the determination unit 101j determines that the first destination identification information corresponding to the second destination identification information is not stored in the destination storage unit of the selected and accepted information management device, the determination unit 101j permits communication with the destination corresponding to the second destination identification information.

When the communication control unit 101m does not permit (prohibits) the communication with the destination corresponding to the second destination identification information, i.e., when the first setting is set and the first destination identification information corresponding to the second destination identification information is not stored in the destination storage unit of the selected and accepted information management device, the notification control unit 101n (corresponding to a portion of means for notifying) outputs to the display unit 109, information instructing to notify information that the communication cannot be carried out. When the display unit 109 accepts the information from the notification control unit 101n, for example, the display unit 109 displays a message such as “Entered number is not registered. Communication cannot be carried out.” on the LCD. The present preferred embodiment described above relates to an example in which the information indicating that the communication cannot be carried out is notified by displaying the above message. However, the present invention is not limited to such an example. For example, the communication device 1 may include a speaker (not illustrated), and notify the information indicating that the communication cannot be carried out by outputting a voice message from the speaker. For example, the voice message may be “Entered number is not registered. Communication cannot be carried out.”

When the communication control unit 101m permits the communication with the destination corresponding to the second destination identification information, the communication unit 101o carries out communication with the destination corresponding to the second destination identification information. When the second destination identification information is a facsimile number, the communication unit 101o carries out facsimile transmission of image data of an original document generated by the original document scanner unit 104 to the destination corresponding to the second destination identification information. When the second destination identification information is a mail address, the communication unit 101o transmits mail attached with image data generated by the original document scanner unit 104.

Further, the communication device 1 can carry out communication at a designated time, i.e., time-designated communication. The control unit 101 accepts a designation of communication time via the operation unit 108. When the control unit 101 accepts a designation of the communication time and a communication start command, the time-designated communication is carried out. In this case, when the first setting is set and the determination unit 101j determines that the first destination identification information corresponding to the second destination identification information is stored in the destination storage unit of the selected and accepted information management device, or when the second setting is set, the communication control unit 101m adds an attribute indicating to permit the communication with respect to a communication job that carries out the time-designated communication (in the present preferred embodiment, a job of transmitting image data by facsimile, or a job of transmitting mail attached with image data). Then, at the designated communication time accepted by the control unit 101, the communication unit 101o determines whether or not the attribute indicating to permit the communication is added. When a determination is made that the attribute indicating to permit the communication is added, the communication unit 101o carries out communication with the destination corresponding to the second destination identification information.

When the communication time is not designated and the control unit 101 accepts the communication start command, a normal communication is carried out. That is, after the control unit 101 accepts the communication start command, when the communication control unit 101m permits the communication with the destination corresponding to the second destination identification information, the communication unit 101o carries out the communication with the destination corresponding to the second destination identification information immediately after the communication becomes capable of being carried out.

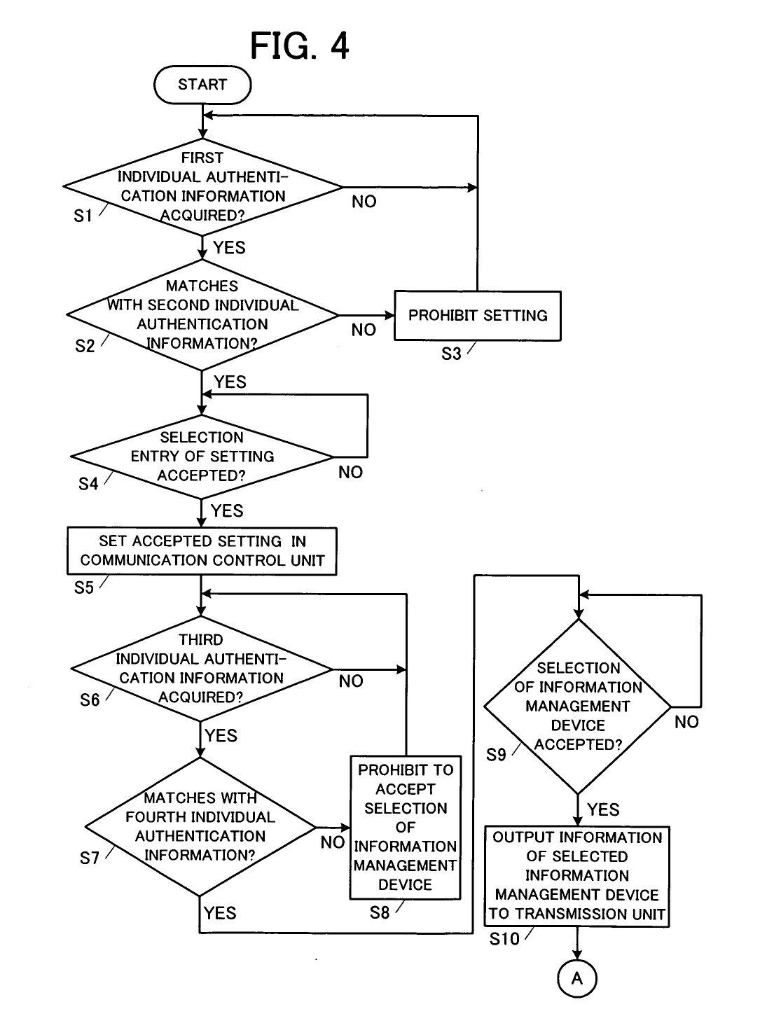

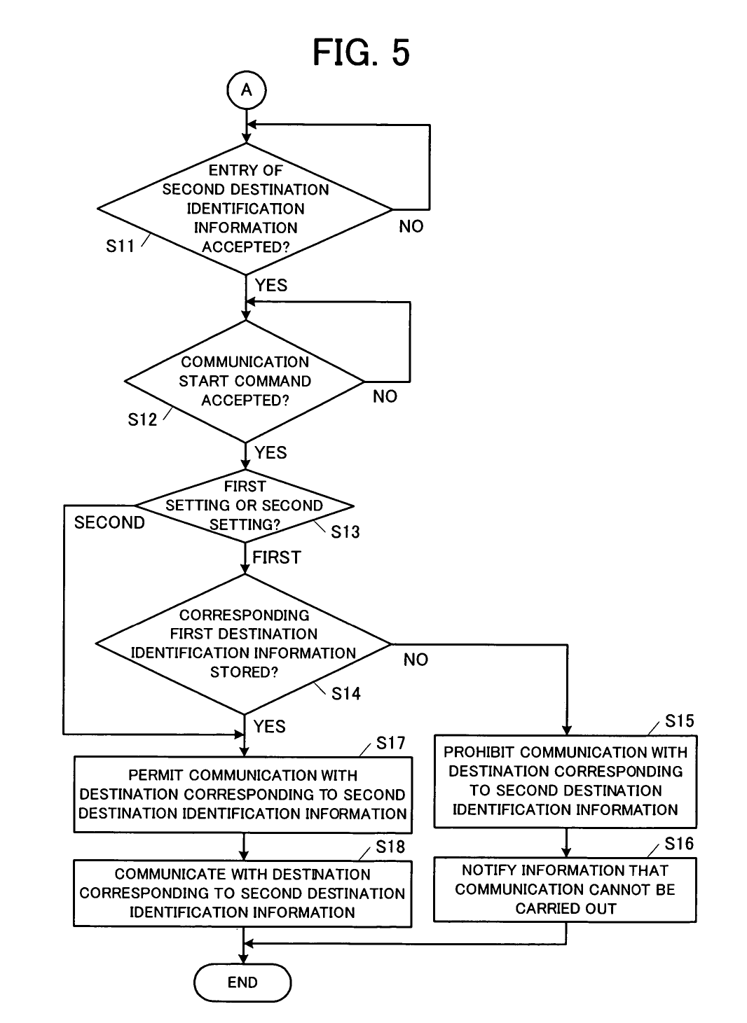

With reference to the flowcharts illustrated in FIGS. 4 and 5, a description will be made of an operation carried out by the communication device 1. First, the first acquiring unit 101b determines whether or not the first individual authentication information has been acquired (step S1) That is, the first acquiring unit 101b determines whether or not the user has entered the first individual authentication information including the user ID and the password from the operation unit 108. When the first acquiring unit 101b determines that the first individual authentication information has not been acquired (step S1: NO), until the first acquiring unit 101b determines that the first individual authentication information has been acquired, the operation of step S1 is repeated. When the first acquiring unit 101b determines that the first individual authentication information has been acquired (step S1: YES), the first prohibiting unit 101b determines whether or not the first individual authentication information acquired by the first acquiring unit 101b matches with the second individual authentication information stored in the first storage unit 101c (step S2).

When the first prohibiting unit 101b determines that the first individual authentication information does not match with the second individual authentication information (step S2: NO), the first prohibiting unit 101a prohibits the setting of the setting accepting unit 101a (step S3). That is, the first prohibiting unit 101a prohibits the setting accepting unit 101a from accepting a selection entry from the outside and carrying out either the first setting or the second setting. Further, after the operation of step S3, the operation of step S1 is executed.

When the first prohibiting unit 101d determines that the first individual authentication information matches with the second individual authentication information (step S2: YES), the setting accepting unit 101a determines whether a selection entry has been accepted for either the first setting or the second setting (step S4). That is, the setting accepting unit 101a determines whether the user has selected either the first setting or the second setting from the operation unit 108. When the setting accepting unit 101a determines that a selection entry corresponding to the first setting and the second setting has not been accepted (step S4: NO), the setting accepting unit 101a repeats the operation of step S4 until accepting the selection entry corresponding to either the first setting or the second setting. When the setting accepting unit 101a determines that the selection entry corresponding to either the first setting or the second setting has been accepted (step S4: YES), the selected and accepted first setting or the second setting is set with the communication control unit 101m (step S5).

Next, the second acquiring unit 101f determines whether or not the third individual authentication information has been acquired (step S6). That is, the second acquiring unit 101f determines whether or not the user has entered the third individual authentication information including the user ID and the password from the operation unit 108. When the second acquiring unit 101f determines that the third individual authentication information has not been acquired (step S6: NO), until the second acquiring unit 101f determines that the third individual authentication information has been acquired, the second acquiring unit 101f repeats the operation of step S6. When the second acquiring unit 101f determines that the third individual authentication information has been acquired (step S6: YES), the second prohibiting unit 101h determines whether or not the third individual authentication information acquired by the second acquiring unit 101f matches with the fourth individual authentication information stored in the second storage unit 101g (step S7).

When the second prohibiting unit 101h determines that the third individual authentication information does not match with the fourth individual authentication information (step S7: NO), the second prohibiting unit 101h prohibits the device selection accepting unit 101e from accepting a selection (step S8). That is, the second prohibiting unit 101h prohibits the device selection accepting unit 101e from accepting the selection of either the first information management device 2 or the second information management device 3 from the outside. Further, after the operation of step S8, the operation of step S6 is executed.

When the second prohibiting unit 101h determines that the third individual authentication information matches with the fourth individual authentication information (step S7: YES), the device selection accepting unit 101e determines whether a selection has been accepted for either the first information management device 2 or the second information management device 3 (step S9). That is, a determination is carried out as to whether the user has selected either the first information management device 2 or the second information management device 3 from the operation unit 108. When the device selection accepting unit 101e determines that a selection has not been accepted for the first information management device 2 and the second information management device 3 (step S9: NO), until a determination is made that one selection is accepted for either the first information management device 2 or the second information management device 3, the operation of step S9 is repeated. When the device selection accepting unit 101e determines that a selection has been accepted for either the first information management device 2 or the second information management device 3 (step S9: YES), the device selection accepting unit 101e outputs information of the selected and accepted first information management device 2 or the second information management device 3 to the transmission unit 101k (step S10).

Next, the destination accepting unit 101i determines whether or not an entry of the second destination identification information has been accepted (step S11). That is, a determination is carried out as to whether or not the second destination identification information such as a facsimile number or a mail address has been entered by the user from the operation unit 108. When the destination accepting unit 101i determines that an entry of the second destination identification information has not been accepted (step S11: NO), until a determination is made that an entry of the second destination identification information has been accepted, the operation of step S11 is repeated. When a determination is made that an entry of the second destination identification information has been accepted by the destination accepting unit 101i (step S11: YES), the control unit 101 determines whether or not a communication start command has been accepted (step S12). For example, when an original document is placed on a prescribed position of the communication device 1 and a start key of the operation unit 108 is operated, the control unit 101 determines that the communication start command has been accepted. When the control unit 101 determines that the communication start command has not been accepted (step S12: NO), until a determination is made that the communication start command has been accepted, the operation of step S12 is repeated. When the control unit 101 determines that the communication start command has been accepted (step S12: YES), the communication control unit 101m determines whether the setting accepting unit 101a has set either the first setting or the second setting (step S13).

When the communication control unit 101m determines that the first setting is set (step S13: FIRST), the determination unit 101j determines whether or not the first destination identification information corresponding to the second destination identification information is stored in the destination storage unit of the information management device selected and accepted by the device selection accepting unit 101e (step S14). That is, the determination unit 101j outputs prescribed information (command) to the transmission unit 101k, and the transmission unit 101k accepts the prescribed information from the determination unit 101j. Then, the transmission unit 101k transmits the second destination identification information and the information requesting a return of the presence/absence information to the information management device selected and accepted by the device selection accepting unit 101e. The reception unit 1011 receives the presence/absence information returned from the information management device. The determination unit 101j determines whether or not the first destination identification information corresponding to the second destination identification information is stored in the destination storage unit of the information management device selected and accepted by the device selection accepting unit 101e in accordance with the presence/absence information received by the reception unit 1011.

When the determination unit 101j determines that the first destination identification information corresponding to the second destination identification information is not stored in the destination storage unit of the selected and accepted information management device (step S14: NO), the communication control unit 101m does not permit communication with the destination corresponding to the second destination identification information, and prohibits the communication with the destination corresponding to the second destination identification information (step S15) Next, the notification control unit 101n outputs to the display unit 109, information instructing to notify the information that the communication cannot be carried out. The display unit 109 notifies the information that the communication cannot be carried out by displaying a message that the communication cannot be carried out on the LCD (step S16).

Meanwhile, when the determination unit 101j determines that the first destination identification information corresponding to the second destination identification information is stored in the destination storage unit of the selected and accepted information management device (step S14: YES), the communication control unit 101m permits the communication with the destination corresponding to the second destination identification information (step S17). When the communication control unit 101m determines at step S13 that the second setting is set (step S13: SECOND), the operation of step S17 is executed. Then, the communication unit 101o carries out communication with the destination corresponding to the second destination identification information (step S18).

As described above, when the first destination identification information corresponding to the second destination identification information is stored in the destination storage unit of the information management device, the communication with the destination corresponding to the second destination identification information is permitted, and the communication is carried out with the destination corresponding to the second destination identification information. That is, when the first destination identification information corresponding to the second destination identification information is not stored in the destination storage unit of the information management device, the communication with the destination corresponding to the second destination identification information is not permitted, and the communication is not carried out with the destination corresponding to the second destination identification information. Therefore, the communication can be prevented from being carried out with the destination corresponding to the destination identification information entered by mistake, i.e., an unintended destination.

In accordance with the presence/absence information, which is information indicating whether or not the first destination identification information corresponding to the second destination identification information is stored in the destination storage unit of the information management device, a determination is carried out as to whether or not the first destination identification information corresponding to the second destination identification information is stored in the destination storage unit of the information management device. Therefore, a determination as to whether or not the first destination identification information corresponding to the second destination identification information is stored in the destination storage unit of the information management device can be carried out by a simple process.

When the first destination identification information corresponding to the second destination identification information is not stored in the destination storage unit of the information management device and the communication with the destination corresponding to the second destination identification information is not permitted, the information indicating that the communication cannot be carried out is notified. Therefore, the user can recognize that the user has entered a wrong destination.

The user can select either the first setting or the second setting. Therefore, the convenience for the user improves. Further, the first setting permits the communication only when the first destination identification information corresponding with the second destination identification information is stored in the destination storage unit of the information management device. The second setting permits the communication regardless of whether or not the first destination identification information corresponding to the second destination identification information is stored in the destination storage unit of the information management device.

The user can select an information management device storing desired first destination identification information from either the first information management device 2 or the second information management device 3. Therefore, the convenience for the user improves. For example, when using the communication device 1 in a company, the first information management device 2 may store the first destination identification information of another branch office or a head office, etc. of the same company, and the second information management device 3 may store the first destination identification information of another company such as a customer. In such case, by selecting the first information management device 2 storing the first destination identification information of other branch office or the head office, etc. of the same company, it is possible to prevent the communication from being carried out with another company by mistake. As a result, it is possible to prevent leakage of confidential information or the like of the company.

When the first individual authentication information does not match with the second individual authentication information, the setting of the first setting or the second setting is prohibited. When the third individual authentication information does not match with the fourth individual authentication information, the selection of the information management device is prohibited to be accepted. Therefore, it is possible to prevent a change from being made to the setting and the information management device from being selected without authenticating an individual. For example, the first setting may be permitted to be used by a user other than a user whose second individual authentication information is stored in the first storage unit 101c and the fourth individual authentication information is stored in the second storage unit 101g (for example, a manger, a person in charge). Then, a communication destination may be limited to a destination stored in the destination storage unit 21 of the first information management device 2.

Further, in the above-described preferred embodiment, the determination unit 101j determines whether or not the first destination identification information corresponding to the second destination identification information is stored in the destination storage unit of the information management device selected and accepted by the device selection accepting unit 101e in accordance with the presence/absence information received by the reception unit 1011. In the following, a description will be made of another preferred embodiment regarding the determination carried out by the determination unit 101j.

In the other preferred embodiment, the transmission unit 101k (corresponding to a second transmitting means) transmits information requesting a return of the first destination identification information and the destination name information (i.e. telephone directory data) stored in the destination storage unit to the information management device, which has been selected and accepted by the device selection accepting unit 101e.

Meanwhile, when the first information management device 2 (or the second information management device 3) receives information from the transmission unit 101k, the first information management device 2 (or the second information management device 3) returns the first destination identification information and the destination name information (i.e. the telephone directory data) stored in the first destination storage unit 21 (or the second destination storage unit 31) to the communication device 1.

The reception unit 1011 (corresponding to a second receiving means) receives the first destination identification information and the destination name information (i.e. the telephone directory data) returned from the information management device. The first destination identification information and the destination name information received by the reception unit 1011 are written in the RAM 103. The determination unit 101j searches the second destination identification information from the first destination identification information and the destination name information received by the receiving unit 1011 to determine whether or not the first destination identification information corresponding to the second destination identification information is stored in the destination storage unit of the information management device selected and accepted by the device selection accepting unit 101e.

Further, in the other preferred embodiment, for each prescribed time interval (for example, every one hour), the transmission unit 101k transmits information requesting a return of the first destination identification information and the destination name information (i.e. the telephone directory data) stored in the destination storage unit to the information management device selected and accepted by the device selection accepting unit 101e. Therefore, the first destination identification information and the destination name information stored in the RAM 103 are updated every prescribed time interval.

As described above, the first destination identification information and the destination name information are received from the information management device, and the first destination identification information corresponding to the second destination identification information is searched from the received first destination identification information and the destination name information. Accordingly, a determination is carried out as to whether or not the first destination identification information corresponding to the second destination identification information is stored in the destination storage unit of the selected and accepted information management device. As a result, it is possible to shorten a period of time when the communication device 1 and the information management device are connected. For example, although the second information management device 3 is connected to the communication device 1 via the router 6 and the Internet 7, in the other preferred embodiment, since the period of time when the communication device 1 and the second information management device 3 are connected is shortened as described above, the communication costs may be reduced. In addition, the information management device is not required to determine whether or not the first destination identification information corresponding to the second destination identification information is stored in the destination storage unit of the information management device. As a result, a processing load of the information management device is reduced.

The communication device 1 can receive one communication start command and carry out communication with a destination corresponding to each of a plurality of second destination identification information. That is, the communication device 1 can carry out a broadcast communication. For example, the communication device 1 can sequentially or concurrently carry out facsimile transmission of the same image data to a destination corresponding to each of a plurality of facsimile numbers (second destination identification information) Alternatively, the communication device 1 can sequentially or concurrently transmit mails attached with the same image data to a destination corresponding to each of a plurality of mail addresses (second destination identification information). Alternatively, the communication device 1 can sequentially or concurrently carry out the facsimile transmission of the image data and the transmission of the mail attached with the image data that is the same as the facsimile-transmission image data to a destination corresponding to a facsimile number (second destination identification information) and a destination corresponding to a mail address (second destination identification information).

For carrying out the broadcast communication, the destination accepting unit 101i can accept an entry of a plurality of second destination identification information. When the destination accepting unit 101i accepts an entry of a plurality of second destination identification information, the transmission unit 101k transmits information requesting a return of the presence/absence information, which is information indicating whether or not the first destination identification information corresponding to each of the plurality of the second destination identification information is stored in the destination storage unit, along with the plurality of the second destination identification information accepted by the destination accepting unit 101i to the information management device selected and accepted by the device selection accepting unit 101e. The determination unit 101j determines whether or not the first destination identification information corresponding to each of the plurality of the second destination identification information is stored in the destination storage unit of the information management device selected and accepted by the device selection accepting unit 101e in accordance with the presence/absence information received by the reception unit 1011.

When the first setting is set by the setting accepting unit 101a, in case the determination unit 101j determines that all of the first destination identification information corresponding to the plurality of the second destination identification information is respectively stored in the destination storage unit of the selected and accepted information management device, the communication control unit 101m permits communication with all destinations corresponding to the plurality of the second destination identification information. That is, when the determination unit 101j determines that all of the first destination identification information corresponding to the plurality of the second destination identification information is stored, the communication control unit 101m permits communication with all of the destinations corresponding to the plurality of the second destination identification information. When the determination unit 101j determines that the first destination identification information is not stored for even one of the plurality of the second destination identification information, the communication control unit 101m does not permit communication with all of the destinations corresponding to the plurality of the second destination identification information. That is, the communication control unit 101m prohibits the communication with all of the destinations corresponding to the plurality of the second destination identification information in such a case.

When the communication control unit 101m does not permit (prohibits) the communication with all of the destinations corresponding to the plurality of the second destination identification information, the notification control unit 101n outputs to the display unit 109 information instructing to notify the information that the communication cannot be carried out and the second destination identification information, which has been determined by the determination unit 101j that corresponding first destination identification information is not stored in the destination storage unit of the selected and accepted information management device. When the display unit 109 receives the information from the notification control unit 101n, the display unit 109 displays a message, for example, “Entered number 06-1234-9999 is not registered. Communication cannot be carried out.”, on the LCD. Accordingly, the user can recognize that the user has entered a wrong destination.

According to the above-described preferred embodiment, when the first setting is set and the determination unit 101j determines that corresponding first destination identification information is not stored for even one of the plurality of the second destination identification information, the communication control unit 101m does not permit communication with all of the destinations corresponding to the plurality of the second destination identification information and prohibits the communication with all of the destinations corresponding to the plurality of the second destination identification information. As another example, the communication control unit 101m may permit only the communication with the destination corresponding to the second destination identification information, which has been determined that corresponding first destination identification information is stored, among the plurality of the second destination identification information. In this case, the communication control unit 101m outputs to the display unit 109 information instructing to notify the second destination identification information, which has been determined by the determination unit 101j that corresponding first destination identification information is not stored in the destination storage unit of the selected and accepted information management device, and information indicating that the communication cannot be carried out with the destination corresponding to the second destination identification information of which a determination has been made that corresponding first destination identification information is not stored.

In the above-described preferred embodiment, the first information management device 2 and the second information management device 3 are the LDAP servers. However, the first information management device 2 and the second information management device 3 are not limited to the LDAP servers if the first information management device 2 and the second information management device 3 can store the destination name information by associating with the first destination identification information for each destination, search the first destination identification information corresponding to the second destination identification information in accordance with the information from the communication device 1, and return the presence/absence information (in the other preferred embodiment, return the first destination identification information and the destination name information) For example, the first information management device 2 and the second information management device 3 may be server devices which include a protocol for accessing a directory server other than the LDAP and capable of returning information according to a request of the communication device 1.

In the above-described preferred embodiment, a description has been made of an example in which the communication device is the Internet facsimile machine. However, the present invention is not limited to such an example. For example, if the communication device can carry out the communication with a destination corresponding to the destination identification information of which an entry from the outside has been accepted, the communication device may be a telephone set, a mobile telephone set, or a personal computer. In the above-described preferred embodiment, image data is transmitted to the destination corresponding to the second destination identification information. When the communication device is a telephone set, a call can be made to a destination corresponding to a telephone number that is the second destination identification information.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication device comprising:
means for accepting an entry of second destination identification information, which is information for identifying a destination;
means for determining whether or not first destination identification information corresponding to the second destination identification information is stored in a destination storing means of an information management device; and
means for permitting communication with a destination corresponding to the second destination identification information when the means for determining determines that the first destination identification information corresponding to the second destination identification information is stored in the destination storing means.

2. The communication device according to claim 1, further comprising:
a first transmitting means for transmitting the second destination identification information and information requesting a return of presence or absence information, which is information indicating whether or not the first destination identification information corresponding to the second destination identification information is stored in the destination storing means, to the information management device; and
a first receiving means for receiving the presence or absence information returned from the information management device,
wherein in accordance with the presence or absence information received by the first receiving means, the means for determining determines whether or not the first destination identification information corresponding to the second destination identification information is stored in the destination storing means.

3. The communication device according to claim 1, further comprising:
a second transmitting means for transmitting information requesting a return of the first destination identification information and the destination name information stored in the destination storing means to the information management device; and
a second receiving means for receiving the first destination identification information and the destination name information returned from the information management device,
wherein the means for determining determines whether or not the first destination identification information corresponding to the second destination identification information is stored in the destination storing means by searching the first destination identification information corresponding to the second destination identification information from the first destination identification information and the destination name information received by the second receiving means.

4. The communication device according to claim 1, further comprising means for notifying information that communication cannot be carried out when the means for permitting does not permit the communication with the destination corresponding to the second destination identification information.

5. The communication device according to claim 1, further comprising:
a setting accepting means for accepting a selection entry from the outside and carrying out one of a first setting and a second setting, wherein the first setting permits the communication only when the first destination identification information corresponding to the second destination identification information is stored in the destination storing means, and the second setting permits the communication regardless of whether or not the first destination identification information corresponding to the second destination identification information is stored in the destination storing means,
wherein when the setting accepting means accepts the selection entry for the second setting, the means for permitting permits the communication with the destination corresponding to the second destination identification information regardless of the determination by the means for determining.

6. The communication device according to claim 5, further comprising:
a first acquiring means for acquiring first individual authentication information, which is information for authenticating an individual, from the outside;
a first storing means for previously storing second individual authentication information, which is information for authenticating an individual; and
a first prohibiting means for prohibiting a setting of the setting accepting means when the first individual authentication information acquired by the first acquiring means does not match with the second individual authentication information stored in the first storing means.

7. The communication device according to claim 1, further comprising:
a device selection accepting means for accepting a selection of one information management device from a plurality of information management devices from the outside,
wherein the means for determining determines whether or not the first destination identification information corresponding to the second destination identification information is stored in the destination storing means of the information management device selected and accepted by the device selection accepting means.

8. The communication device according to claim 7, further comprising:
a second acquiring means for acquiring third individual authentication information, which is information for authenticating an individual, from the outside;
a second storing means for previously storing fourth individual authentication information, which is information for authenticating an individual; and
a second prohibiting means for prohibiting the device selection accepting means from accepting the selection when the third individual authentication information acquired by the second acquiring means does not match with the fourth individual authentication information stored in the second storing means.

9. A communication method comprising:
a destination accepting step of accepting an entry of second destination identification information, which is information for identifying a destination, from outside;
a determining step of determining whether or not first destination identification information corresponding to the second destination identification information is stored in a destination storing means of an information management device; and
a permitting and prohibiting step of permitting communication with a destination corresponding to the second destination identification information when a determination is made at the determining step that the first destination identification information corresponding to the second destination identification information is stored in the destination storing means, and prohibiting the communication with the destination corresponding to the second destination identification information when a determination is made at the determining step that the first destination identification information corresponding to the second destination identification information is not stored in the destination storing means.

10. The communication method according to claim 9, further comprising:
a first transmitting step of transmitting the second destination identification information and information requesting a return of presence or absence information, which is information indicating whether or not the first destination identification information corresponding to the second destination identification information is stored in the destination storing means, to the information management device; and
a first receiving step of receiving the presence or absence information returned from the information management device after the first transmitting step,
wherein at the determining step, in accordance with the presence or absence information received at the first receiving step, a determination is carried out as to whether or not the first destination identification information corresponding to the second destination identification information is stored in the destination storing means.

11. The communication method according to claim 9, further comprising:
a second transmitting step of transmitting information requesting a return of the first destination identification information and the destination name information stored in the destination storing means to the information management device; and
a second receiving step of receiving the first destination identification information and the destination name information returned from the information management device after the second transmitting step,
wherein at the determining step, a determination is carried out as to whether or not the first destination identification information corresponding to the second destination identification information is stored in the destination storing means by searching the first destination identification information corresponding to the second destination identification information from the first destination identification information and the destination name information received at the second receiving step.

12. The communication method according to claim 9, further comprising:
a notifying step of notifying information that the communication cannot be carried out when the communication with the destination corresponding to the second destination identification information is prohibited at the permitting and prohibiting step.

13. The communication method according to claim 9, further comprising:
a setting accepting step of accepting a selection entry from the outside and carrying out one of a first setting and a second setting, wherein the first setting permits the communication only when the first destination identification information corresponding to the second destination identification information is stored in the destination storing means, and the second setting permits the communication regardless of whether or not the first destination identification information corresponding to the second destination identification information is stored in the destination storing means,
wherein at the permitting and prohibiting step, when the selection entry for the second setting is accepted at the setting accepting step, the communication with the destination corresponding to the second destination identification information is permitted regardless of the determination at the determining step.

14. The communication method according to claim 13, further comprising:
a first acquiring step of acquiring first individual authentication information, which is information for authenticating an individual, from the outside; and
a first storing step of previously storing second individual authentication information, which is information for authenticating an individual,
wherein at the setting accepting step, when the first individual authentication information acquired at the first acquiring step does not match with the second individual authentication information stored at the first storing step, the setting of the first setting or the second setting is prohibited from being accepted.

15. The communication method according to claim 9, further comprising:
a device selection accepting step of accepting a selection of one information management device from a plurality of information management devices from the outside,
wherein at the determining step, a determination is carried out as to whether or not the first destination identification information corresponding to the second destination identification information is stored in the destination storing means of the information management device selected and accepted at the device selection accepting step.

16. The communication method according to claim 15, further comprising:
a second acquiring step of acquiring third individual authentication information, which is information for authenticating an individual, from the outside; and
a second storing step of previously storing fourth individual authentication information, which is information for authenticating an individual,
wherein at the device selection accepting step, when the third individual authentication information acquired at the second acquiring step does not match with the fourth individual authentication information stored at the second storing step, the selection of the information management device is prohibited from being accepted.

17. A communication system including a communication device and an information management device connected in a manner that communication can be carried out, the communication system comprising:
the information management device including means for storing destination name information by associating with first destination identification information for identifying a destination for each destination; and
the communication device including:
means for accepting an entry of second destination identification information, which is information for identifying a destination, from outside,
means for determining whether or not the first destination identification information corresponding to the second destination identification information is stored in the means for storing of the information management device, and
means for permitting communication with a destination corresponding to the second destination identification information when the means for determining determines that the first destination identification information corresponding to the second destination identification information is stored in the destination storing means.

18. The communication system according to claim 17, wherein the communication device further comprises:
a first transmitting means for transmitting the second destination identification information and information requesting a return of presence or absence information, which is information indicating whether or not the first destination identification information corresponding to the second destination identification information is stored in the means for storing, to the information management device, and
a first receiving means for receiving the presence or absence information returned from the information management device,
wherein the means for determining determines whether or not the first destination identification information corresponding to the second destination identification information is stored in the means for storing in accordance
with the presence or the absence information received by the first receiving means; and
wherein the information management device further comprises a transmitting means for determining whether or not the first destination identification information corresponding to the second destination identification information is stored in the means for storing when the information requesting the return of the presence or absence information is received from the communication device, and transmitting the presence or absence information as a determination result.

19. The communication system according to claim 17, wherein the communication device further comprises:
a second transmitting means for transmitting information requesting a return of the first destination identification information and the destination name information stored in the means for storing to the information management device, and
a second receiving means for receiving the first destination identification information and the destination name information returned from the information management device,
wherein the means for determining determines whether or not the first destination identification information corresponding to the second destination identification information is stored in the means for storing by searching the first destination identification information corresponding to the second destination identification information from the first destination identification information and the destination name information received by the second receiving means, and
wherein the information management device further comprises means for transmitting the first destination identification information and the destination name information stored in the means for storing to the communication device when the information requesting the return of the first destination identification information and the destination name information stored in the means for storing is received from the communication device.
